(19) United States
(12) Patent Application Publication
(10) Pub. No.: US 2026/0237807 A1
(43) Pub. Date: Aug. 13, 2026

(54) Secondary Battery

(71) Applicant: LG Energy Solution, Ltd., Seoul (KR)

(72) Inventor: Jin Uk Do, Daejeon (KR)

(73) Assignee: LG Energy Solution, Ltd., Seoul (KR)

(21) Appl. No.: 19/531,163

(22) Filed: Feb. 5, 2026

(30) Foreign Application Priority Data
Feb. 10, 2025 (KR) 10-2025-0016994

(51) Int. Cl. H01M 50/188; H01M 50/15; H01M 50/184; H01M 50/55; H01M 50/553; H01M 50/566; H01M 50/586; H01M 50/593

(52) U.S. Cl. CPC H01M 50/188; H01M 50/15; H01M 50/184; H01M 50/55; H01M 50/553; H01M 50/566; H01M 50/586; H01M 50/593; H01M 2220/20

(57) ABSTRACT

A secondary battery according to an embodiment of the present disclosure includes a case, an electrode assembly, and a cap assembly. An opening is formed in the case. The electrode assembly is inserted into the case through the opening and includes an electrode portion and a plurality of foil tabs formed on the electrode portion. The cap assembly seals the opening of the case into which the electrode assembly is inserted. The cap assembly includes a cap plate, a lower insulating plate, and an electrode terminal. A through-hole is formed in the cap plate. The lower insulating plate is disposed below the cap plate, and has a protruding portion formed at an inner end thereof. The electrode terminal is disposed above the cap plate, is inserted into the through-hole, and has, on an outer surface thereof, a first fitting groove into which the protruding portion is fitted.

### CROSS REFERENCES TO RELATED APPLICATIONS

This application is based on and claims priority from Korean Patent Application No. 10-2025-0016994, filed on Feb. 10, 2025, with the Korean Intellectual Property Office, the disclosure of which is incorporated herein in its entirety by reference.

### TECHNICAL FIELD

The present disclosure relates to a secondary battery.

### BACKGROUND

Secondary batteries having high applicability across product groups and having electrical characteristics such as high energy density are widely applied not only to the portable devices but also to, for example, electric vehicles (EVs) and hybrid electric vehicles (HEVs) driven by electric power sources.

These secondary batteries not only have a primary advantage in that the use of fossil fuels may be dramatically reduced, but also have an advantage in that no by-products are generated due to energy use. Therefore, the secondary batteries are attracting attention as a new energy source for improving eco-friendliness and energy efficiency.

The types of secondary batteries currently used widely include, for example, lithium-ion batteries, lithium polymer batteries, nickel-cadmium batteries, nickel-metal hydrogen batteries, and nickel zinc batteries. An operating voltage of such unit secondary battery cells ranges from about 2.5 V to about 4.5 V.

The secondary batteries may be classified, according to the shape of a battery case, into can-type secondary batteries in which an electrode assembly is accommodated in a metal can, and pouch-type secondary batteries in which an electrode assembly is accommodated in a pouch formed of an aluminum laminate sheet. The can-type secondary batteries may be classified, according to the shape of the metal can, into cylindrical secondary batteries and prismatic secondary batteries.

### SUMMARY

The present disclosure provides a secondary battery including a cap assembly capable of reducing the overall resistance of the secondary battery, improving space utilization, and improving sealing by preventing welded portions from being exposed to the outside.

A secondary battery according to an embodiment of the present disclosure includes a case, an electrode assembly, and a cap assembly. An opening is formed in the case. The electrode assembly is inserted into the case through the opening and includes an electrode portion and a plurality of foil tabs formed on the electrode portion. The cap assembly seals the opening of the case into which the electrode assembly is inserted. The cap assembly includes a cap plate, a lower insulating plate, and an electrode terminal. A through-hole is formed in the cap plate. The lower insulating plate is disposed below the cap plate, and has a protruding portion formed at an inner end thereof. The electrode terminal is disposed above the cap plate, is inserted into the through-hole, and has, on an outer surface thereof, a first fitting groove into which the protruding portion is fitted.

The electrode terminal includes a terminal body and a terminal protrusion. The terminal body is formed above the cap plate. The terminal protrusion protrudes from a lower surface of the terminal body and is inserted into the through-hole. An insertion groove into which a current-collecting protrusion is inserted is recessed upwardly at a center of the terminal protrusion. The first fitting groove is formed in an outer surface of the terminal protrusion.

A rigidity-reinforcing insert may be formed within the lower insulating plate.

One end portion of the rigidity-reinforcing insert may be positioned within the protruding portion.

A second fitting groove is formed on an inner circumferential surface of the insertion groove, and a fitting portion fitted into the second fitting groove may be formed on an outer circumferential surface of the current-collecting protrusion.

The current-collecting protrusion may be formed in a truncated-cone shape having a diameter that decreases from a lower portion toward an upper portion.

In this case, the lower diameter of the current-collecting protrusion may be larger than a diameter of the insertion groove.

An upper insulating plate may be formed above the cap plate, and a sealing gasket may be interposed between the upper insulating plate and the terminal protrusion.

An upper surface of the insertion groove may be formed at a position higher than the upper insulating plate.

A terminal-protrusion-side end portion of the sealing gasket may extend from the lower surface of the terminal body to the protruding portion.

The sealing gasket may be formed in a serpentine meander shape.

After the current-collecting protrusion is inserted into the insertion groove, welding may be performed on an upper surface of the electrode terminal to couple the electrode terminal and the current-collecting protrusion.

The plurality of foil tabs may be formed in one direction of an electrode assembly.

The plurality of foil tabs may be formed in both directions of the electrode assembly.

After the electrode assembly and the current-collecting plate are coupled, a first insulating member may be attached to the current-collecting plate. Then, after an outer surface of the electrode assembly is wrapped with a second insulating member, the electrode assembly may be inserted into a case. Then, an outer surface of the case into which the electrode assembly is inserted may be wrapped with a third insulating member.

According to another embodiment of the present disclosure, a vehicle including the secondary battery is provided.

A cap assembly according to another embodiment of the present disclosure is a structure configured to seal an opening of a secondary battery case. The cap assembly includes: a cap plate in which a through-hole is formed; a lower insulating plate disposed under the cap plate and having a protruding portion formed at an inner end thereof; and an electrode terminal disposed above the cap plate, inserted into the through-hole, and having, on an outer surface thereof, a first fitting groove into which the protruding portion is fitted.

The electrode terminal includes a terminal body formed above the cap plate, and a terminal protrusion protruding from a lower surface of the terminal body and inserted into the through-hole. The terminal protrusion has an insertion groove formed by being recessed upwardly at a center thereof, into which the current-collecting protrusion is inserted, and the first fitting groove is formed on an outer surface of the terminal protrusion.

The cap assembly further includes an upper insulating plate formed above the cap plate, and a sealing gasket is interposed between the upper insulating plate and the terminal protrusion.

A terminal-protrusion-side end of the sealing gasket extends from a lower surface of the terminal body to the protruding portion.

According to the present disclosure, an overall resistance of the secondary battery may be reduced, a space utilization efficiency may be improved, and a sealing performance may be enhanced by preventing welded portions from being exposed to the outside.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a cross-sectional view illustrating a cap assembly, according to the related art.

FIG. 2 is a perspective view illustrating a secondary battery, according to an embodiment of the present disclosure.

FIG. 3 is an exploded perspective view illustrating a cap assembly of the secondary battery, according to an embodiment of the present disclosure.

FIG. 4 is a perspective view illustrating an electrode assembly in which a plurality of first and second foil tabs are formed on an electrode portion in the secondary battery, according to an embodiment of the present disclosure.

FIG. 5 is a view illustrating a first electrode plate in the secondary battery, according to an embodiment of the present disclosure.

FIG. 6 is a view illustrating a second electrode plate in the secondary battery, according to an embodiment of the present disclosure.

FIGS. 7 and 8 are cross-sectional views illustrating a cap assembly, according to a first embodiment of the present disclosure.

FIG. 9 is a cross-sectional view illustrating a cap assembly, according to a second embodiment of the present disclosure.

FIG. 10 is a cross-sectional view illustrating a cap assembly, according to a third embodiment of the present disclosure.

FIG. 11 is a cross-sectional view illustrating a cap assembly, according to a fourth embodiment of the present disclosure.

FIG. 12 is a view illustrating a process in which foil tabs and current-collecting plates are coupled in a secondary battery, according to an embodiment of the present disclosure.

FIG. 13 is a view illustrating a process in which a cap assembly and current-collecting plates are coupled in a secondary battery, according to an embodiment of the present disclosure.

FIG. 14 is a view illustrating a process in which current-collecting plates and foil tabs are coupled in a secondary battery, according to an embodiment of the present disclosure, when the foil tabs are formed in opposite directions.

FIG. 15 is a view illustrating a process in which cap assemblies are coupled to the current-collecting plates.

FIG. 16 is a view illustrating a process in which insulating members are attached in a state in which an electrode assembly and the current-collecting plates are coupled.

FIG. 17 is a schematic perspective view illustrating a vehicle including a secondary battery, according to an embodiment of the present disclosure.

Corresponding reference characters indicate corresponding components throughout the several views of the drawings, but different reference characters may be given as necessary. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

The present disclosure may be modified in various ways and may have various embodiments, and specific embodiments will be illustrated and described in detail in the detailed description. However, this is not intended to limit the present disclosure to specific embodiments, and it should be understood that the present disclosure includes all modifications, equivalents, and substitutes falling within the spirit and technical scope of the present disclosure.

The terms used in the present disclosure are used only for the purpose of describing particular embodiments and are not intended to limit the present disclosure. As used herein, singular forms include plural forms unless the context clearly indicates otherwise. In the present disclosure, it should be understood that the terms such as “include” and “have” are intended to specify the presence of stated features, numbers, steps, operations, elements, components, or combinations thereof described in the specification, but do not preclude the presence or addition of one or more other features, numbers, steps, operations, elements, components, or combinations thereof.

Hereinafter, embodiments of the present disclosure will be described with reference to the accompanying drawings.

In a prismatic secondary battery, an electrode assembly is accommodated in a case made of a metallic material, and a cap assembly is coupled to an open end of the case.

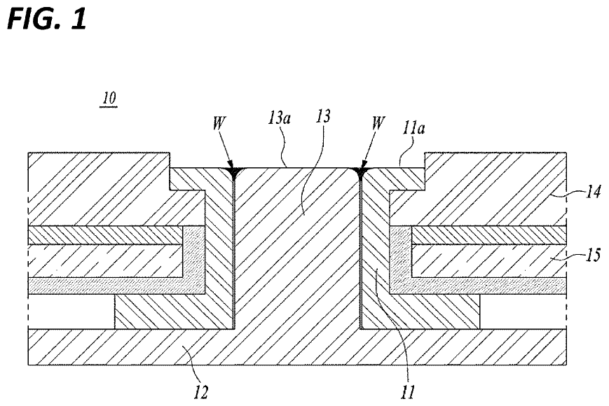

FIG. 1 is a cross-sectional view illustrating a cap assembly according to the related art.

As illustrated in FIG. 1, a cap assembly 10 according to the related art is manufactured by inserting a current-collecting protrusion 13 of a current-collecting plate 12 into a hollow portion of a rivet 11 and then welding (W) an upper end 11a of the rivet 11 and an upper end 13a of the current-collecting protrusion 13.

In such a cap assembly 10 according to the related art, by using the rivet 11 to couple an electrode terminal 14 and a cap plate 15, the number of components and hence the overall resistance of the secondary battery may be increased, and the presence of the rivet 11 may reduce space utilization.

In addition, a gap formed at the welded portion (W) may be exposed to the outside, and through the exposed welded portion (W), an electrolyte or gas inside the case may leak to the outside, and external moisture or air may penetrate into the case, resulting in degradation of the efficiency of the battery.

In consideration of these issues, the present disclosure provides a technology in which, instead of using a rivet, a heat-fusion layer is formed between a cap assembly and an electrode terminal, and as a result, the welded portions are not exposed to the outside, thereby reducing the overall resistance of a secondary battery, improving the space utilization, and improving the sealing.

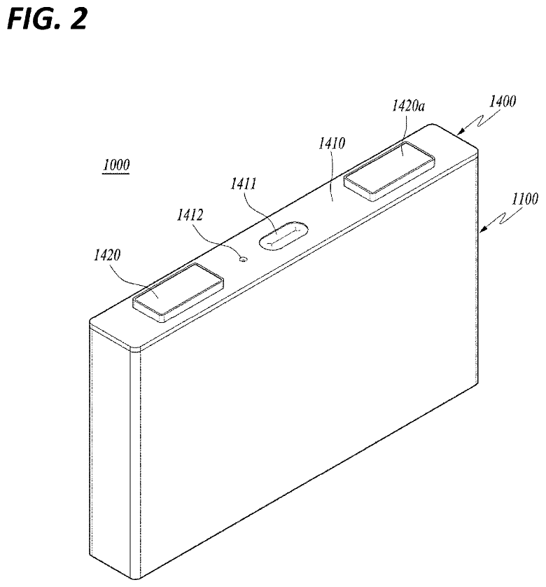

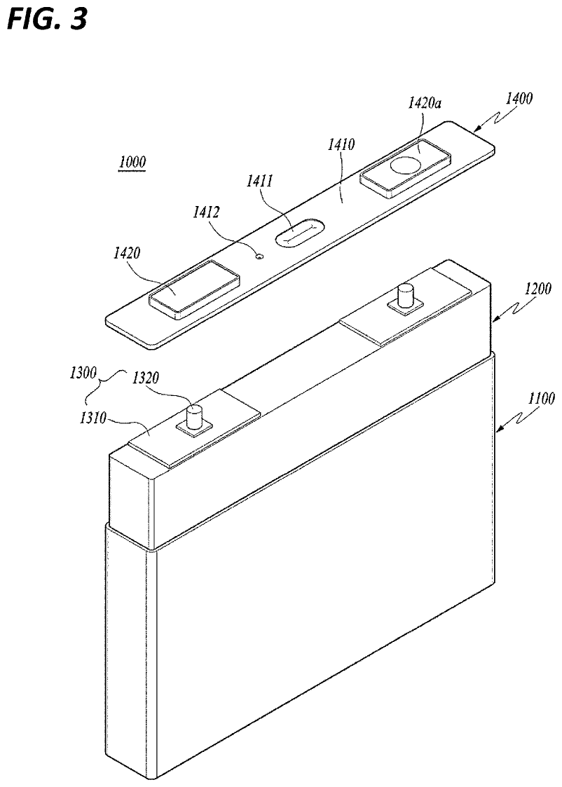

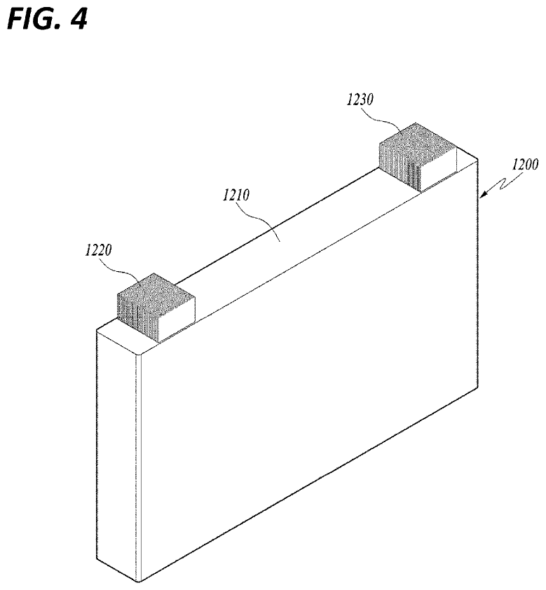

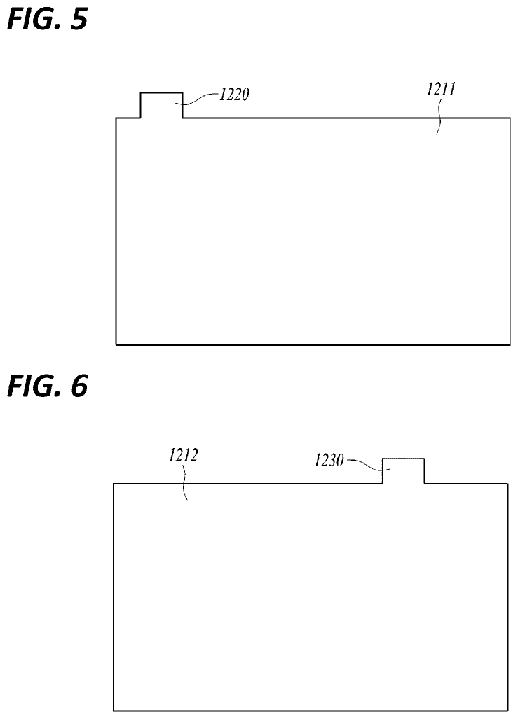

FIG. 2 is a perspective view illustrating a secondary battery, according to an embodiment of the present disclosure, FIG. 3 is an exploded perspective view illustrating a cap assembly of the secondary battery, according to an embodiment of the present disclosure, FIG. 4 is a perspective view illustrating an electrode assembly in which a plurality of first and second foil tabs are formed on an electrode portion in the secondary battery, according to an embodiment of the present disclosure, FIG. 5 is a view illustrating a first electrode plate in the secondary battery, according to an embodiment of the present disclosure, and FIG. 6 is a view illustrating a second electrode plate in the secondary battery, according to an embodiment of the present disclosure.

As illustrated in FIGS. 2 and 3, a secondary battery 1000, according to an embodiment of the present disclosure, includes a case 1100, an electrode assembly 1200, a current-collecting plate 1300, and a cap assembly 1400.

The case 1100 forms an exterior of the secondary battery 1000. The case 1100 has an internal space configured to accommodate the electrode assembly 1200, and an opening may be formed in one surface thereof. In this embodiment, the case 1100 has a rectangular parallelepiped shape; however, the case 1100 is not limited thereto and may be variously modified. The case 1100 may be made of a rigid material capable of protecting the electrode assembly 1200 accommodated therein. For example, the case 1100 may be made of a metal such as aluminum or stainless steel.

An electrolyte may be accommodated in the case 1100 together with the electrode assembly 1200. The electrolyte may include a lithium salt such as LiPF₆ or LiBF₄ dissolved in an organic solvent such as EC, PC, DEC, EMC, or DMC. The electrolyte may be in a liquid, solid, or gel state.

The electrode assembly 1200 is accommodated inside the case 1100. As illustrated in FIG. 4, the electrode assembly 1200, according to an embodiment, includes an electrode portion 1210, a plurality of first foil tabs 1220, and a plurality of second foil tabs 1230. The plurality of first and second foil tabs 1220 and 1230 are disposed at respective ends of the electrode portion 1210. In another embodiment, the first foil tabs 1220 may be disposed on one side surface of the electrode portion 1210, and the second foil tabs 1230 may be disposed on the other side surface of the electrode portion 1210. The plurality of first foil tabs 1220 are aligned with each other, and the plurality of second foil tabs 1230 are aligned with each other.

As illustrated in FIGS. 5 and 6, the electrode portion 1210 includes a plurality of first electrode plates 1211, a plurality of second electrode plates 1212, and a separator.

The active materials may be applied to the plurality of first electrode plates 1211 and the plurality of second electrode plates 1212. On the plurality of first electrode plates 1211, an active material such as a transition metal oxide may be applied to the metal plates such as aluminum. The plurality of first electrode plates 1211 may be positive electrode plates. On the plurality of second electrode plates 1212, an active material such as graphite or carbon may be applied to the metal plates such as copper or nickel. The plurality of second electrode plates 1212 may be negative electrode plates.

A separator (not illustrated) is disposed between adjacent ones of the plurality of first and second electrode plates 1211 and 1212 to prevent a short circuit between the plurality of first and second electrode plates 1211 and 1212. The separator may be made of polyethylene, polypropylene, or a composite thereof.

The electrode portion 1210 may be formed by disposing a separator between a first electrode plate 1211 and a second electrode plate 1212 that are sequentially arranged. In an embodiment, the electrode portion 1210 may be formed by current-collecting a first electrode plate 1211, a separator, a second electrode plate 1212, and a separator in this order tens to hundreds of times.

In the present embodiment, the electrode assembly 1200 includes one electrode portion 1210. However, in another embodiment, the electrode assembly 1200 may include a plurality of electrode portions 1210. The plurality of electrode portions 1210 may be electrically connected to each other.

Foil tabs 1220 and 1230, on which no active material is applied, are formed at one end of each of the plurality of first and second electrode plates 1211 and 1212. In an embodiment, the electrode plates 1211 and 1212 and the foil tabs 1220 and 1230 may be integrally formed by cutting a predetermined portion of a single metal plate using, for example, a laser so as to leave the electrode plates 1211 and 1212 and the foil tabs 1220 and 1230. The plurality of foil tabs 1220 and 1230 may be formed in a direction toward the cap assembly 1400.

When the plurality of first and second electrode plates 1211 and 1212 are stacked, the plurality of first foil tabs 1220 overlap with each other at a first position. The plurality of second foil tabs 1230 overlap with each other at a second position. For example, the plurality of first foil tabs 1220 having the same polarity are grouped at the first position, and the plurality of second foil tabs 1230 are grouped at the second position. The first position and the second position are spaced apart from each other on the electrode plates 1211 and 1212, and the grouped plurality of first foil tabs 1220 and the grouped plurality of second foil tabs 1230 may be spaced apart from each other in a length direction of the electrode assembly 1200.

The plurality of foil tabs 1220 and 1230 overlapped at the respective positions may be connected to a current-collecting plate using, for example, ultrasonic welding or laser welding, respectively, in order to facilitate current flow.

The current-collecting plate 1300 includes a current-collecting body 1310 and a current-collecting protrusion 1320.

The plurality of foil tabs 1220 and 1230 are bent and welded to the current-collecting body 1310. The current-collecting protrusion 1320 is formed at a center of the current-collecting body 1310.

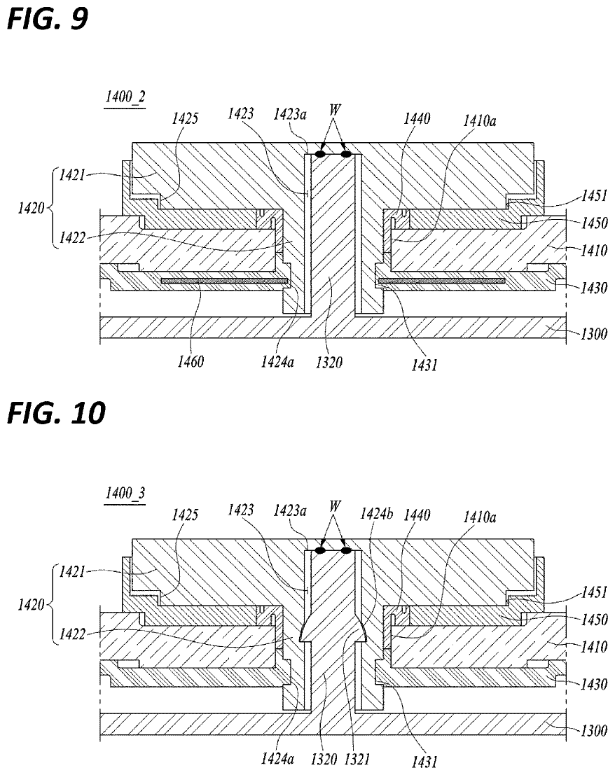

The current-collecting protrusion 1320 protrudes upward from an upper surface of the current-collecting body 1310, and is coupled to an electrode terminal 1420 at an upper surface 1421a of an insertion groove 1421 of the electrode terminal 1420 by, for example, welding, thereby electrically connecting the electrode assembly and the electrode terminal 1420 (see, e.g., FIG. 8). In another embodiment, the current-collecting protrusion 1320 of the current-collecting body 1310 may be coupled to a terminal protrusion 1422 (see, e.g., FIG. 9) of an electrode terminal 1420 to electrically connect the electrode assembly 1200 and the electrode terminal 1420.

The current-collecting plate 1300 may be made of the same material as the plurality of foil tabs 1220 and 1230, and may have a predetermined thickness, for example, a thickness of about 0.8 mm to about 1.2 mm. By using the current-collecting plate having a relatively large thickness, an insulating effect may be improved and damage to the separator may be prevented or suppressed.

An insulating material may be disposed under the current-collecting plate 1300. The insulating material may be an insulating plate or an insulating film.

After welding the plurality of first foil tabs 1220 to each other and welding the plurality of second foil tabs 1230 to each other, the current-collecting plates 1300 are disposed on the first foil tabs 1220 and the second foil tabs 1230, respectively.

After bending the plurality of first foil tabs 1220 and the plurality of second foil tabs 1230, the current-collecting plates 1300 are welded to the plurality of first foil tabs 1220 and the plurality of second foil tabs 1230. The welding may be performed using, for example, ultrasonic welding or laser welding.

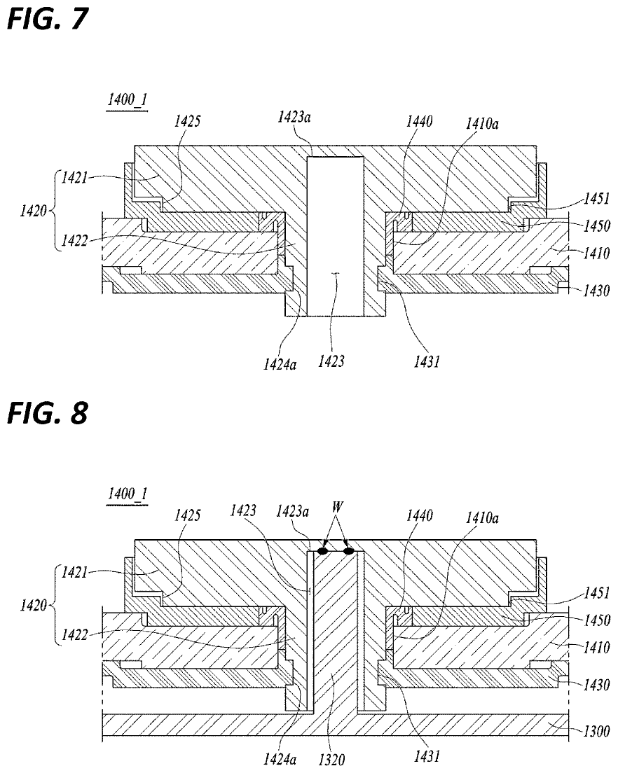

The cap assembly 1400 seals an opening of the case 1100 in which the electrode assembly 1200 is accommodated. In the present disclosure, the cap assembly 1400 is provided to reduce the overall resistance of the secondary battery, improve space utilization, and improve sealing by preventing welded portions from being exposed to the outside. Various embodiments of the cap assembly 1400 will be described in detail with reference to FIGS. 7 to 11.

FIGS. 7 and 8 are cross-sectional views illustrating a cap assembly according to a first embodiment of the present disclosure, in which FIG. 7 is a cross-sectional view illustrating a state in which a current-collecting plate 1300 is omitted, and FIG. 8 is a cross-sectional view illustrating a state in which the current-collecting plate 1300 is coupled.

As illustrated in FIGS. 7 and 8, a cap assembly 1400_1 according to the first embodiment of the present disclosure may include a cap plate 1410, an electrode terminal 1420, a lower insulating plate 1430, a sealing gasket 1440, and an upper insulating plate 1450. The electrode terminal 1420 is fastened to the lower insulating plate 1430, and the current-collecting plate 1300 is coupled to the electrode terminal 1420 without a rivet, thereby forming a cap assembly.

The cap plate 1410 has a plate shape covering an opening of the case 1100 and includes at least one through-hole 1410a. The cap plate 1410 may have a shape corresponding to the shape of the opening of the case 1100. The cap plate 1410 may be formed of the same material as the case 1100, and the cap plate 1410 may be fixed to the case 1100 by a method such as laser welding.

A vent portion 1411 and an electrolyte injection port 1412 may be formed in the cap plate 1410. The vent portion 1411 is opened when an internal pressure of the case 1100 exceeds a reference value. In the present embodiment, the vent portion 1411 is formed in the cap plate 1410. However, in another embodiment, the vent portion 1411 may be formed in the case 1100. An electrolyte may be injected into the case 1100 through the electrolyte injection port 1412.

The electrode terminal 1420 may be formed above the cap plate 1410. The electrode terminal 1420 is electrically connected to the foil tabs 1220 and 1230 through the current-collecting plate 1300.

The electrode terminal 1420 may include a terminal body 1421 and a terminal protrusion 1422.

The terminal body 1421 may have a plate shape having a circular or rectangular shape.

The terminal protrusion 1422 protrudes downward from a lower surface of the terminal body 1421 by a predetermined length. An insertion groove 1423 having a predetermined diameter is formed at the center of the terminal protrusion 1422. The insertion groove 1423 is formed by being recessed upwardly at a center of the terminal protrusion 1422. An upper surface 1423a of the insertion groove 1423 is formed at a position higher than the upper insulating plate 1450. In addition, a first fitting groove 1424a is formed on an outer surface of the terminal protrusion 1422. The current-collecting protrusion 1320 may be inserted into the insertion groove 1423.

The lower insulating plate 1430 may be disposed under the cap plate 1410. A protruding portion 1431 is formed at an inner end of the lower insulating plate 1430. The protruding portion 1431 protrudes toward the terminal protrusion 1422 and is fitted into the first fitting groove 1424a formed on the outer surface of the terminal protrusion 1422. The lower insulating plate 1430 may electrically insulate the cap plate 1410 from the current-collecting plate 1300 while performing a rivet function for fixing the electrode terminal 1420 to the cap assembly 1400_1.

An upper insulating plate 1450 may be disposed between the electrode terminal 1420 and the cap plate 1410. The upper insulating plate 1450 electrically insulates the electrode terminal 1420 from the cap plate 1410.

A first step 1451 may be formed at an outer end portion of the upper insulating plate 1450, and a second step 1425 corresponding to the first step 1451 may be formed at an outer end portion of the electrode terminal 1420. As the second step 1425 is fitted into the first step 1451, the electrode terminal 1420 and the upper insulating plate 1450 may be easily coupled to each other.

In addition, a sealing gasket 1440 may be disposed at an inner end portion of the upper insulating plate 1450. For example, the sealing gasket 1440 may be interposed between the inner end portion of the upper insulating plate 1450 and an outer surface of the terminal protrusion 1422.

The sealing gasket 1440 prevents or suppresses the leakage of an electrolyte or gas inside the case 1100 to the outside and prevents or suppresses the penetration of moisture or air from the outside into the case 1100. In this case, a terminal-protrusion-side end of the sealing gasket 1440 may extend from a lower surface of the terminal body 1421 to the protruding portion 1431, thereby further improving sealing performance.

The sealing gasket 1440 may be formed in a serpentine meander shape. By forming the sealing gasket 1440 in the serpentine meander shape, horizontal stress applied by the upper insulating plate 1450 may be buffered.

As illustrated in FIG. 7, after the cap assembly 1400_1 is configured, the current-collecting protrusion 1320 of the current-collecting plate 1300 may be inserted into the insertion groove 1423, and then, as illustrated in FIG. 8, welding (W) may be performed at an upper surface of the electrode terminal 1420 (e.g., an upper surface of the electrode body 1421) so as to couple the electrode terminal 1420 and the current-collecting protrusion 1320.

According to the cap assembly 1400_1 of the first embodiment of the present disclosure configured as described above, the lower insulating plate 1430 may electrically insulate the cap plate 1410 from the current-collecting plate 1300 while performing a rivet function for fixing the electrode terminal 1420 to the cap assembly 1400_1. For example, as the protruding portion 1431 of the lower insulating plate 1430 is fitted into and fastened to the first fitting groove 1424a of the terminal protrusion 1422, the lower insulating plate 1430 replaces a rivet function, so that the number of components constituting the cap assembly 1400_1 may be reduced. Accordingly, an overall resistance of the secondary battery may be reduced, and the space utilization may be improved. In addition, since welding is performed at the upper surface of the electrode terminal 1420, no gap is present at a welded portion and the welded portion is not exposed to the outside, so that sealing performance may be improved.

FIG. 9 is a cross-sectional view illustrating a cap assembly, according to a second embodiment of the present disclosure.

Referring to FIG. 9, a cap assembly 1400_2, according to a second embodiment of the present disclosure, may include a cap plate 1410, an electrode terminal 1420, a lower insulating plate 1430, a sealing gasket 1440, an upper insulating plate 1450, and a rigidity-reinforcing insert 1460.

In the second embodiment, the cap plate 1410, the electrode terminal 1420, the lower insulating plate 1430, the sealing gasket 1440, and the upper insulating plate 1450 are substantially the same as those of the above-described first embodiment, and thus redundant descriptions thereof will be omitted.

The upper and lower insulating plates 1430 and 1450 may be made of plastic materials having high insulation properties and durability, such as polypropylene (PP), polyamide (PA), or polycarbonate (PC). The electrode terminal 1420 may be formed of a metal material, in which a negative electrode terminal may be made of copper or nickel-plated copper, and a positive electrode terminal may be made of, for example, aluminum or nickel-plated aluminum.

In the above-described first embodiment, since the protruding portion 1431 of the lower insulating plate 1430 made of a plastic material is press-fitted into the first fitting groove 1424a of the terminal protrusion 1422 made of a metal material, the durability of the protruding portion 1431 of the lower insulating plate 1430 may be weakened.

In order to prevent or suppress the issue described above, in the second embodiment, a rigidity-reinforcing insert 1460 may be formed within the lower insulating plate 1430 to reinforce the mechanical strength of the lower insulating plate 1430.

The rigidity-reinforcing insert 1460 may be made mainly of a metal material such as stainless steel, aluminum, or copper.

Alternatively, the rigidity-reinforcing insert 1460 may be made mainly of a material such as fiber-reinforced plastic (FRP), which has high strength and low weight while exhibiting excellent electrical insulation properties, or a ceramic reinforcement material, which has an excellent high-temperature durability and electrical insulation properties.

Since the rigidity-reinforcing insert 1460 is intended to reinforce the rigidity of the protruding portion 1431, according to an embodiment, one end portion of the rigidity-reinforcing insert 1460 may be positioned within the protruding portion 1431, and the other end portion may be positioned at a predetermined location under the cap plate 1410.

FIG. 10 is a cross-sectional view illustrating a cap assembly, according to a third embodiment of the present disclosure.

Referring to FIG. 10, a cap assembly 1400_3, according to the third embodiment of the present disclosure, may include a cap plate 1410, an electrode terminal 1420, a lower insulating plate 1430, a sealing gasket 1440, and an upper insulating plate 1450, and differs from the above-described first embodiment only in the shapes of the terminal protrusion 1422 and the current-collecting protrusion 1320. Accordingly, redundant descriptions will be omitted.

In the third embodiment, a second fitting groove 1424b may be formed on an inner circumferential surface of the insertion groove 1423 formed at a center of the terminal protrusion 1422, and a fitting portion 1321 fitted into the second fitting groove 1424b may be formed on an outer circumferential surface of the current-collecting protrusion 1320.

The second fitting groove 1424b may be formed in an inclined shape in which a width thereof decreases from a lower portion toward an upper portion of the terminal protrusion 1422. In addition, the fitting portion 1321 may be formed to have a shape corresponding to that of the second fitting groove 1424b.

As illustrated in FIG. 10, after the cap assembly 1400_3 is configured, the current-collecting protrusion 1320 of the current-collecting plate 1300 may be inserted into the insertion groove 1423, and then welding (W) may be performed at an upper surface of the electrode terminal 1420 to couple the electrode terminal 1420 and the current-collecting protrusion 1320.

In this case, since the fitting portion 1321 of the current-collecting protrusion 1320 is welded in a state of being fitted into the fitting groove 1424b of the terminal protrusion 1422, coupling strength between the current-collecting plate 1300 and the electrode terminal 1420 may be improved.

In addition, since the fitting portion 1321 and the fitting groove 1424b are formed in an inclined shape having a narrower upper portion and a wider lower portion, friction between the fitting portion 1321 and the insertion groove 1423 may be minimized when the current-collecting protrusion 1320 is press-fitted into the insertion groove 1423, thereby facilitating a fitting operation.

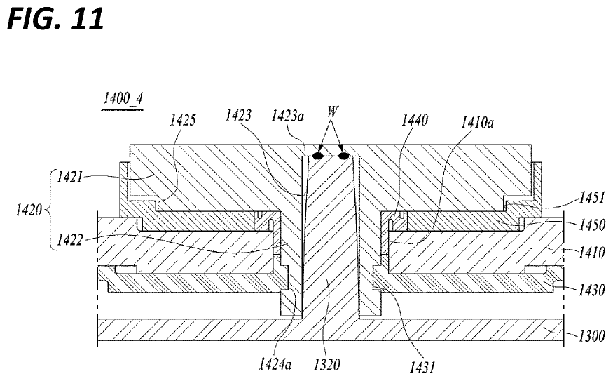

FIG. 11 is a cross-sectional view illustrating a cap assembly, according to a fourth embodiment of the present disclosure.

Referring to FIG. 11, a cap assembly 1400_4, according to the fourth embodiment of the present disclosure, may include a cap plate 1410, an electrode terminal 1420, a lower insulating plate 1430, a sealing gasket 1440, and an upper insulating plate 1450, and differs from the above-described first embodiment only in the shape of the current-collecting protrusion 1320. Accordingly, redundant descriptions will be omitted.

In the fourth embodiment, the current-collecting protrusion 1320 may be formed in a truncated-cone shape having a trapezoidal cross section in which an upper portion is narrower and a lower portion is wider. For example, the current-collecting protrusion 1320 may be formed in a truncated-cone shape having a diameter that decreases from a lower portion toward an upper portion.

In contrast, the insertion groove 1423 may be formed such that upper and lower portions thereof have the same diameter. In this case, the current-collecting protrusion 1320 may be inserted into the insertion groove 1423 in a press-fit manner.

As illustrated in FIG. 11, after the cap assembly 1400_4 is configured, the current-collecting protrusion 1320 of the current-collecting plate 1300 may be inserted into the insertion groove 1423, and then welding (W) may be performed at an upper surface of the electrode terminal 1420 to couple the electrode terminal 1420 and the current-collecting protrusion 1320.

In this case, since the current-collecting protrusion 1320 is welded while being inserted into the insertion groove 1423 in a press-fit manner, coupling strength between the current-collecting plate 1300 and the electrode terminal 1420 may be improved.

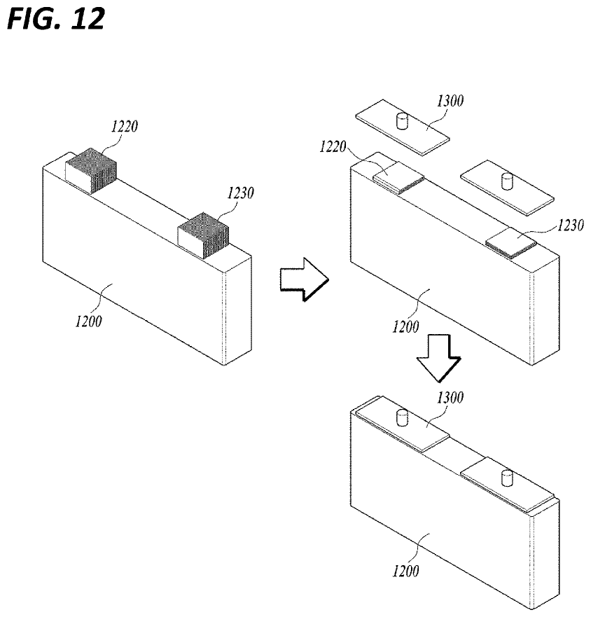

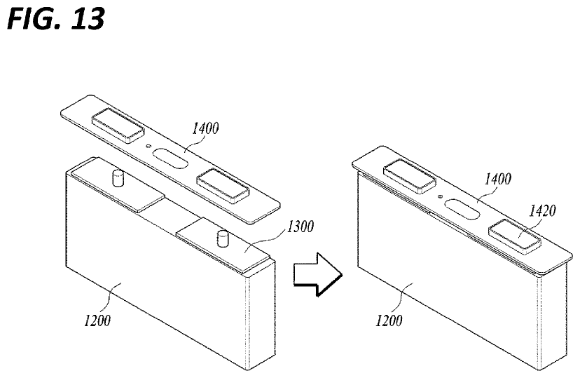

FIG. 12 is a view illustrating a process in which foil tabs and current-collecting plates are coupled in a secondary battery according to an embodiment of the present disclosure, and FIG. 13 is a view illustrating a process in which a cap assembly and current-collecting plates are coupled in the secondary battery according to an embodiment of the present disclosure.

As illustrated in FIGS. 12 and 13, foil tabs 1220 and 1230 are respectively welded on the current-collecting plates 1300. The foil tabs 1220 and 1230 are respectively arranged on the current-collecting plates from different directions with respect to the current-collecting protrusion 1320 of each current-collecting plate 1300. The foil tabs 1220 and 1230 may be positioned so as not to interfere with each other. Accordingly, welding positions of the foil tabs 1220 and 1230 may be located between the current-collecting plates 1300 and an insulating member of the cap assembly 1400.

The current-collecting plates 1300 may be provided for a positive electrode and a negative electrode, respectively. In this case, an insulating member is disposed under the current-collecting plates, such that the current-collecting plates and the electrode assembly are electrically insulated from each other.

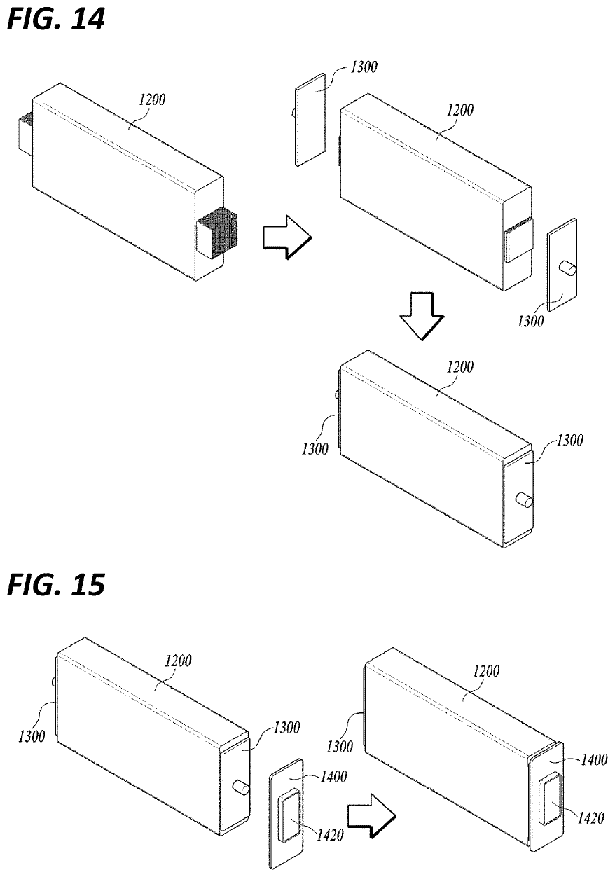

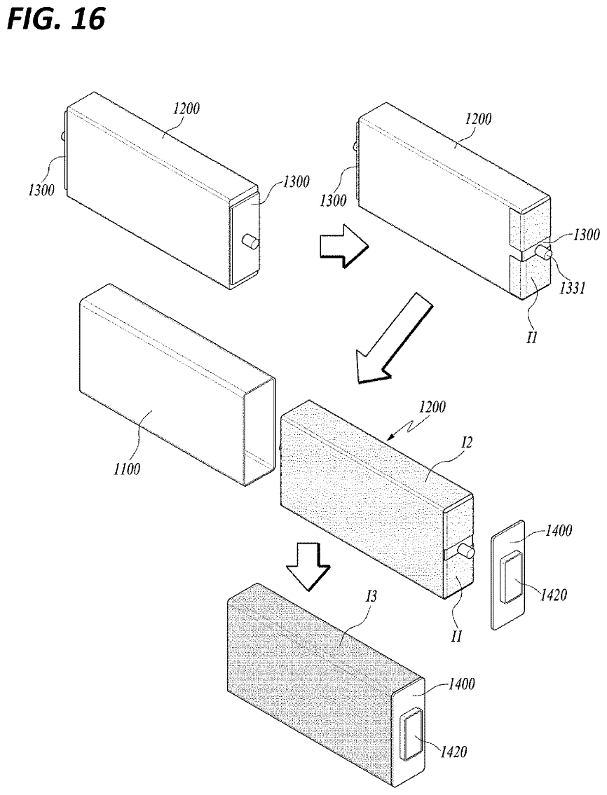

FIG. 14 is a view illustrating a process in which current-collecting plates and foil tabs are coupled in a secondary battery, according to an embodiment of the present disclosure, when the foil tabs are formed in opposite directions. FIG. 15 is a view illustrating a process in which cap assemblies are coupled to the current-collecting plates, and FIG. 16 is a view illustrating a process in which insulating members are attached in a state in which an electrode assembly and the current-collecting plates are coupled.

In FIGS. 12 and 13, positive electrode foil tabs and negative electrode foil tabs are both formed in the same direction. However, as illustrated in FIGS. 14 and 15, the electrode assembly may be configured such that the positive electrode foil tabs and the negative electrode foil tabs are formed in different directions. Accordingly, the current-collecting plates 1300 may be coupled to opposite side surfaces of the electrode assembly 1200.

Meanwhile, as illustrated in FIG. 16, after the electrode assembly 1200 and the current-collecting plates 1300 are coupled, first insulating members I1 may be attached to the current-collecting plates 1300. Through this configuration, a short circuit between the foil tabs and the cap assembly 1400 may be prevented.

After the first insulating members I1 are attached, an outer surface of the electrode assembly 1200 may be wrapped with a second insulating member I2, and then the electrode assembly 1200 may be inserted into a case 1100.

Next, an outer surface of the case 1100 may be wrapped with a third insulating member I3 to complete the manufacture of the secondary battery. Here, the first to third insulating members I1 to I3 may be, for example, insulating tapes.

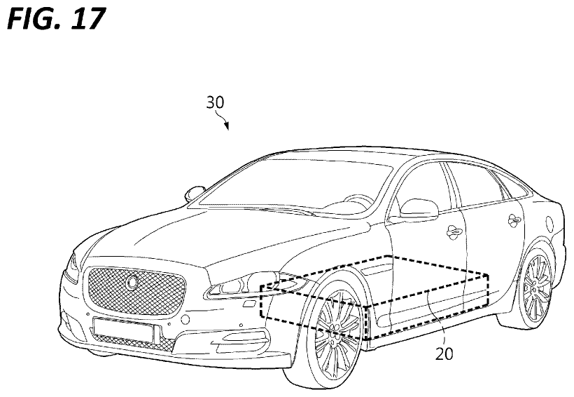

FIG. 17 is a schematic perspective view illustrating a vehicle including a secondary battery, according to an embodiment of the present disclosure.

Referring to FIG. 17, a vehicle 30, according to an embodiment of the present disclosure, may include one or more battery packs 20 each including one or more secondary batteries according to the above-described embodiments. The vehicle 30 according to the present disclosure may be, for example, an electric vehicle, a hybrid vehicle, or a plug-in hybrid vehicle. The vehicle 30 includes various types of vehicles, such as four-wheeled vehicles, as well as two-wheeled or three-wheeled vehicles. The vehicle 30 may operate by receiving power from the battery pack 20 according to an embodiment of the present disclosure.

While the embodiments of the present disclosure have been described, it will be appreciated by one of ordinary skill or knowledge in the art that the embodiments of the present disclosure may be changed or modified in various ways within the scope that does not depart from the technical scope of the various embodiments of the present disclosure defined in the claims attached herein below.

What is claimed is:

1. A secondary battery comprising:
a case having an opening formed therein;
an electrode assembly inserted into the case through the opening and including electrode portion and a plurality of foil tabs formed on the electrode portion; and
a cap assembly configured to seal the opening of the case into which the electrode assembly is inserted,
wherein the cap assembly includes:
a cap plate having a through-hole formed therein,
a lower insulating plate disposed below the cap plate, and including a protruding portion formed at an inner end thereof, and
an electrode terminal disposed above the cap plate, inserted into the through-hole, and including, on an outer surface thereof, a first fitting groove into which the protruding portion is fitted.

2. The secondary battery according to claim 1, wherein the electrode terminal includes:
a terminal body formed above the cap plate, and
a terminal protrusion protruding from a lower surface of the terminal body and inserted into the through-hole, the terminal protrusion having an insertion groove recessed upwardly at a center of the terminal protrusion, into which a current-collecting protrusion is inserted, and the first fitting groove formed an outer surface of the terminal protrusion.

3. The secondary battery according to claim 1, wherein a rigidity-reinforcing insert is formed within the lower insulating plate.

4. The secondary battery according to claim 3, wherein one end portion of the rigidity-reinforcing insert is positioned within the protruding portion.

5. The secondary battery according to claim 2, wherein a second fitting groove is formed on an inner circumferential surface of the insertion groove, and a fitting portion is formed on an outer circumferential surface of the current-collecting protrusion and configured to be fitted into the second fitting groove.

6. The secondary battery according to claim 2, wherein the current-collecting protrusion is formed in a truncated-cone shape having a diameter that decreases from a lower portion toward an upper portion.

7. The secondary battery according to claim 6, wherein a lower diameter of the current-collecting protrusion is larger than a diameter of the insertion groove.

8. The secondary battery according to claim 2, wherein an upper insulating plate is formed above the cap plate, and a sealing gasket is interposed between the upper insulating plate and the terminal protrusion.

9. The secondary battery according to claim 8, wherein an upper surface of the insertion groove is formed at a position higher than the upper insulating plate.

10. The secondary battery according to claim 8, wherein a terminal-protrusion-side end portion of the sealing gasket extends from the lower surface of the terminal body to the protruding portion.

11. The secondary battery according to claim 8, wherein the sealing gasket is formed in a serpentine meander shape.

12. The secondary battery according to claim 2, wherein after the current-collecting protrusion is inserted into the insertion groove, welding is performed on an upper surface of the electrode terminal to couple the electrode terminal and the current-collecting protrusion.

13. The secondary battery according to claim 1, wherein the plurality of foil tabs are formed in one direction of an electrode assembly.

14. The secondary battery according to claim 1, wherein the plurality of foil tabs are formed in opposite directions of the electrode assembly.

15. The secondary battery according to claim 1, wherein after the electrode assembly and the current-collecting plate are coupled, a first insulating material is attached to the current-collecting plate,
after an outer surface of the electrode assembly is wrapped with a second insulating member, the electrode assembly is inserted into a case, and
an outer surface of the case into which the electrode assembly is inserted is wrapped with a third insulating material.

16. A vehicle comprising the secondary battery according to claim 1.

17. A cap assembly that seals an opening of a secondary battery case, the cap assembly comprising:
a cap plate in which a through-hole is formed;
a lower insulating plate disposed under the cap plate and having a protruding portion formed at an inner end thereof; and
an electrode terminal disposed above the cap plate, inserted into the through-hole, and having, on an outer surface thereof, a first fitting groove into which the protruding portion is fitted.

18. The cap assembly according to claim 17, wherein the electrode terminal includes:
a terminal body formed above the cap plate, and
a terminal protrusion protruding from a lower surface of the terminal body, inserted into the through-hole, the terminal protrusion having an insertion groove recessed upwardly at a center thereof, into which the current-collecting protrusion is inserted, and the first fitting groove formed on an outer surface of the terminal protrusion.

19. The cap assembly according to claim 18, wherein the cap assembly further includes an upper insulating plate formed above the cap plate, and a sealing gasket is interposed between the upper insulating plate and the terminal protrusion,

20. The cap assembly according to claim 19, wherein a terminal-protrusion-side end of the sealing gasket extends from a lower surface of the terminal body to the protruding portion.
